(19) United States
(12) Patent Application Publication
(10) Pub. No.: US 2023/0117714 A1
(43) Pub. Date: Apr. 20, 2023

(54) MOTORIZED PENTAGRAM ARMATURE

(71) Applicant: Eric Talbot, Portland, OR (US)

(72) Inventor: Eric Talbot, Portland, OR (US)

(21) Appl. No.: 17/503,719

(22) Filed: Oct. 18, 2021

(51) Int. Cl. F16M 11/20

(52) U.S. Cl. CPC F16M 11/2042; F16M 2200/063

(57) ABSTRACT

A motorized pentagram armature comprises a parallelogram with a bridge piece positioned at a centroid base, to enable pivotal mounting of the armature to the bridge piece. Plural motors allow movement of the elements of the armature to allow manual or automated positioning of any article carried on the end of a reach arm, for positional movement of the article.

### BACKGROUND

This disclosure relates to armatures, and more particularly to a pentagram armature that is motorized for controlled positioning, suitable for many uses.

FIG. 1 illustrates an equipoise armature in accordance with the prior art, as disclosed in U.S. Pat. No. 9,458,961, issued Oct. 14, 2016, entitled EQUIPOISE ARMATURE, by the inventor of the present disclosure.

In the lamp armature configuration shown, the extension arms 32, 34 (corresponding to arms 12, 14 of FIG. 5) are of unequal length and an optional counter weight 36 is positioned at the outer end of shorter arm 34, to counter balance the weight of lamp or other item 38, positioned at the far end of arm 32. Central arms 40, 42 are substantially the same length in this configuration. Arms 40 and 40 are pivotally connected to arms 32, 34 in spaced arrangement, via pivot members 44.

Bridge 46 is connected at pivot points 48, 50 to each of central arms 40, 42, and a mounting stand arm 52 is connected generally centrally of the bridge to allow pivoting of the entire assembly. The mounting stand arm is suitably rotationally mounted to base 54 to allow rotation of the lamp assembly as illustrated by arc 56, whether by rotation of arm 52 relative to the base 54 or rotation of the base 54 relative to the surface on which the base sits. In operation, the longitudinal axis of the bridge remains parallel to the longitudinal axes of the extension arms.

This configuration allows manual movement and provides positioning of lamp/item 38 to any desired position in its range of reach.

### SUMMARY

In accordance with the disclosure, an armature is constructed as a lever beam comprised of a parallelogram with opposing extensions of two of its opposite sides, and a bridge-piece mid parallelogram to provide a physical location (at the device centroid) for a lever pivot point, with controllable movement of the positionable features, such as by motorized control.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a diagram of a simple balance beam/lever with symmetrical loading in accordance with the prior art;

FIG. 2 is a perspective view of an improved motorized pentagram armature illustrating automation control points;

FIG. 3 is a close-in view of the automation control points of FIG. 2;

FIG. 4 is a view illustrating the changes effected by operation of the mast to bridge segment motor;

FIG. 5 is a close-in view of the motor operation of FIG. 4;

FIG. 6 is a view illustrating the changes effected by operation of the pentagram corner angle motor;

FIG. 7 is a close-in view of the motor operation of FIG. 6;

FIG. 8 is a perspective view illustrating movement of the far end of the reach arm segment as controlled by operation of the 3 motors;

FIG. 9 is a view illustrating a range of movement provided by the device; and

FIG. 10 is a view illustrating the addition of an optional counterbalancing configuration.

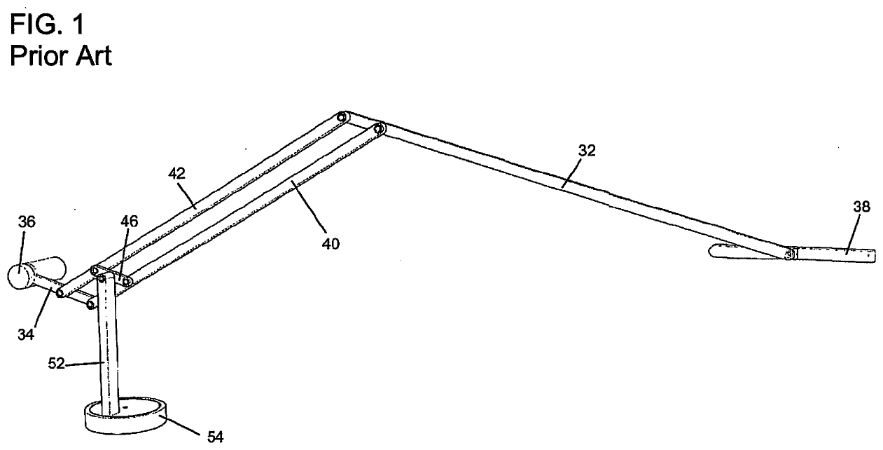

### DETAILED DESCRIPTION

The system according to a preferred embodiment of the present disclosure comprises a motorized pentagram armature.

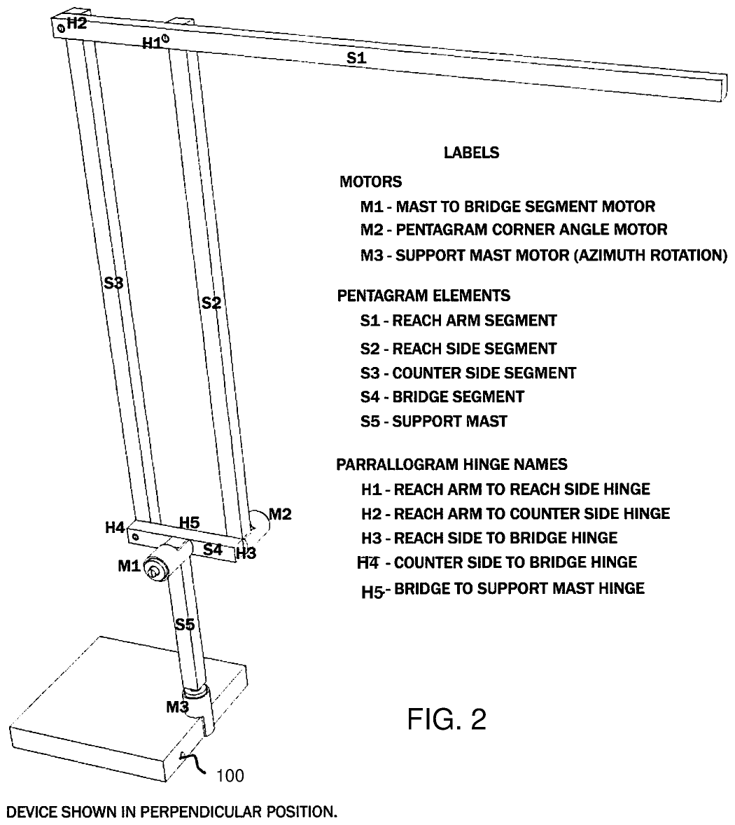

Referring now to FIG. 2 is a perspective view of an improved motorized pentagram armature illustrating automation control points, the armature is illustrated mounted to a base 100, which has support mast motor M3, which provides azimuth rotation to the armature. A support mast S5 is mounted operationally to the motor at a first end and mounts mast to bridge segment motor M1 at the opposite end of the support mast. Motor M1 has a bridge segment S4 mounted thereto via bridge to support mast hinge H5. Bridge segment S4 has reach side to bridge hinge H3 at one end thereof, mounting pentagram corner angle motor M2 thereon and reach side segment S2 extending away from the hinge point. The other end of bridge segment S4 mounts counter side to bridge hinge H4, from which counter side segment S3 extends. The ends of reach side segment S2 and counter side segment S3 that are opposite from hinges H3 and H4 mount to reach arm segment S1, via reach arm to reach side hinge H1 and reach arm to counter side hinge H2. Reach arm segment S1 extends a distance away from the hinge points.

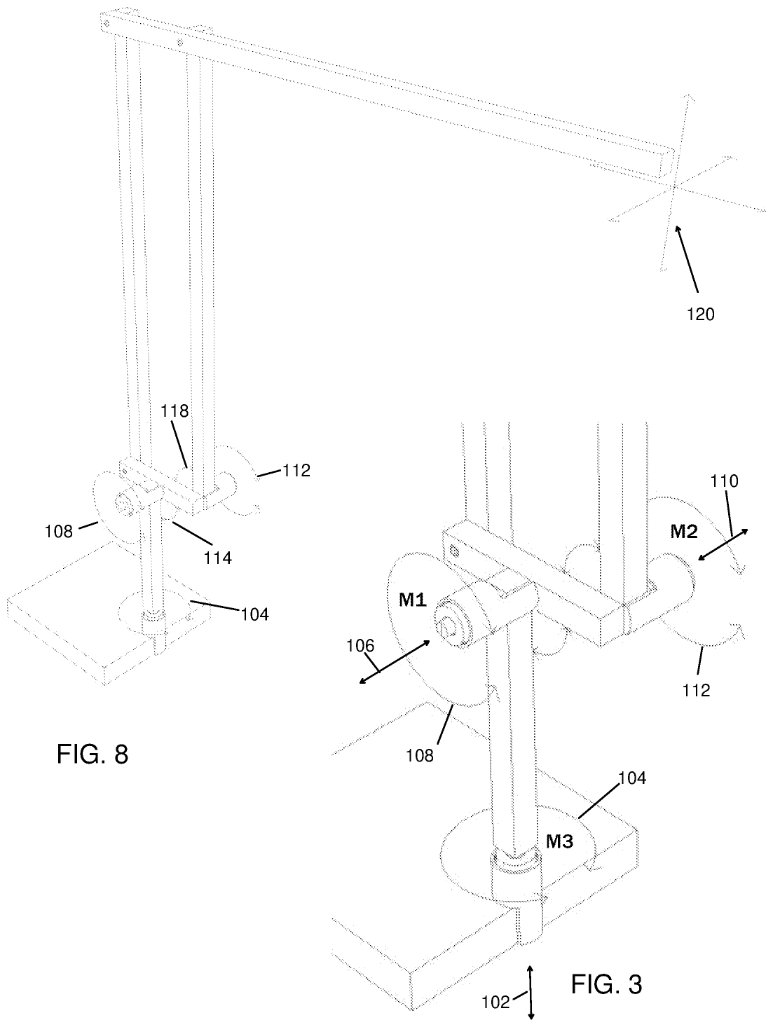

Referring now FIG. 3, a close-in view of the automation control points of FIG. 2, motor M3 provides rotation of support mast S5 about the axis 102 to provide rotational movement illustrated by arc 104. Motor M1 provides rotation of bridge segment S4 about the axis 106 to provide rotational movement illustrated by arc 108. Motor M2 provides rotation of reach side segment S2 about the axis 110 to provide rotational movement illustrated by arc 112.

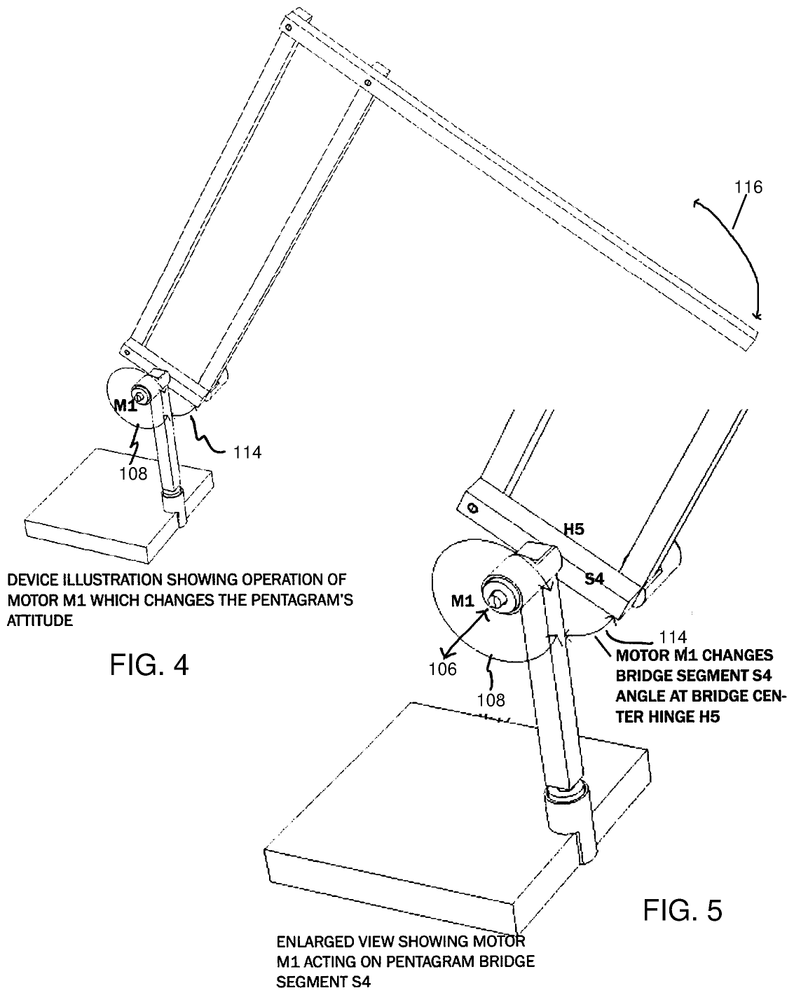

Referring now to FIG. 4 and FIG. 5, which are a view illustrating the changes effected by operation of the mast to bridge segment motor and a close-in view of the same, rotation of motor M1 translates the bridge segment S4 about axis 106 resulting on movement along arc 114, changing the angle of bridge segment S4 at bridge center hinge H5, ultimately moving the far end of reach arm segment S1 in an upward or downward arc 116. Thus, operation of bridge motor M1 ultimately controls raising or lowering of the far end of the reach arm segment, where operation of the pentagram corner angle motor M2 governs the extension/retraction of the reach arm segment.

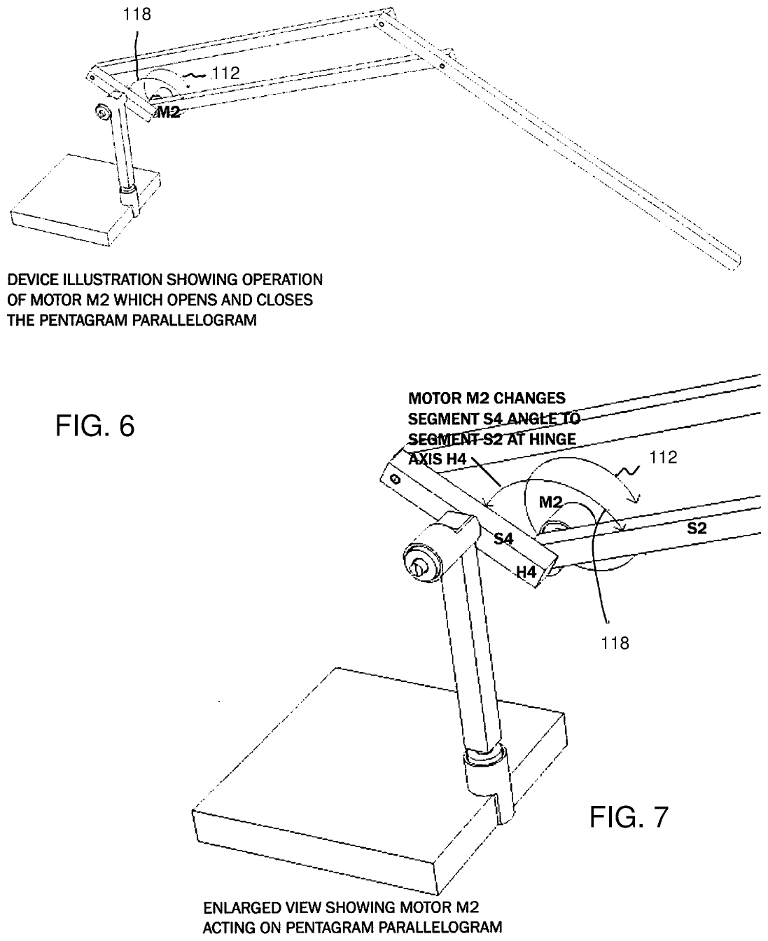

With reference to FIG. 6, a view illustrating the changes effected by operation of the pentagram corner angle motor, together with FIG. 7, a close-in view of the motor operation of FIG. 6, rotation of motor M2 translates the reach side segment S2 about axis 110 resulting on movement along arc 114, changing the angle of the reach side segment S2 in relation to bridge segment S4 at reach side to bridge hinge H3, ultimately moving the far end of reach arm segment S1 outwardly or inwardly relative to the position of support mast S5, changing the angle 118 of reach side segment S2 to bridge segment S4.

In operation, by selective operation of the motors M1, M2 and M3, movement of the distal end of reach arm segment S1 may be accomplished to position it in a desired location in x-y-z planes 120 of FIG. 8, which is a perspective view illustrating movement of the far end of the reach arm segment as controlled by operation of the 3 motors.

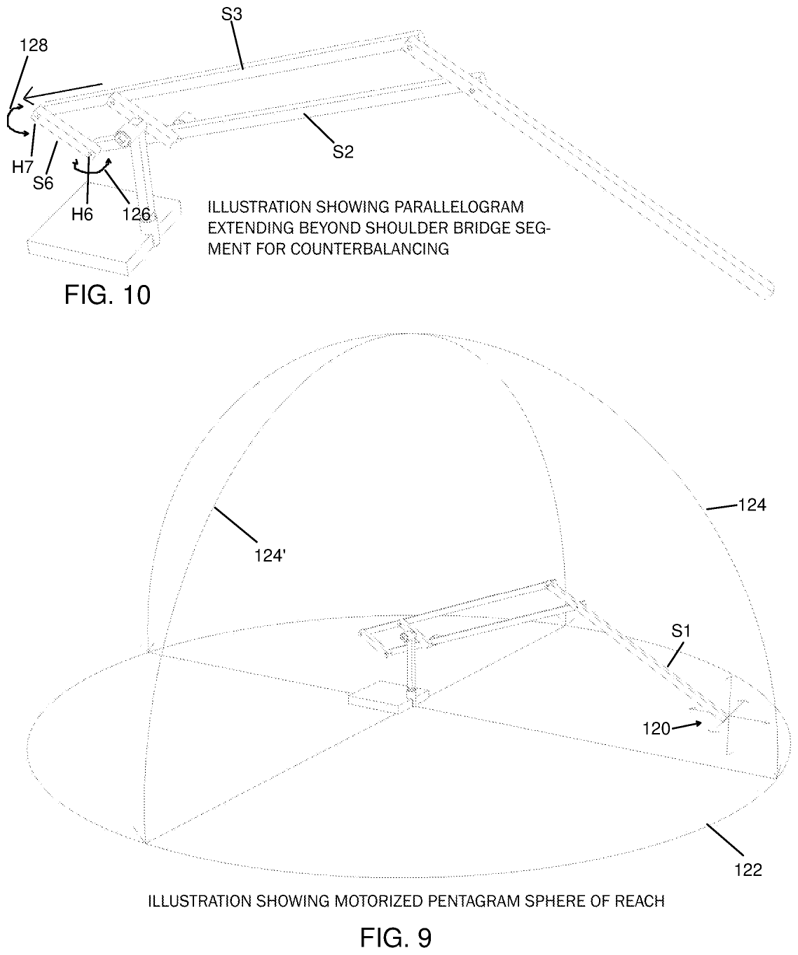

FIG. 9 is a view illustrating a range of movement provided by the device where the end of reach arm segment S1 can be positioned within the hemisphere defined by circle 122 and arcs 124, 124′. This allows for controlled operation to position whatever is mounted to the end of reach arm S1 at a desired position.

FIG. 10 is a view illustrating the addition of an optional counterbalancing configuration if desired for a particular application, such as when a heavier object is mounted to the distal end of reach arm S1. In this configuration reach side segment S2 and counter side segment S3 extend beyond hinge points H3 and H4, and are provided with a connecting shoulder bridge segment S6 that mounts to reach side segment S2 via hinge H6 and to counter side segment S3 via hinge H7 that allows rotation as shown by arcs 126 and 128.

The operation of the motors for positioning the device can be either manual control in real-time where the user employs an actuator such a joystick, a game controller, dials, etc., or can be automated through a programmed app for pre-set locations, for example.

The 3 motors can be controlled by software which translates manual hardware or programmed software input toward the 3-axis positioning result. While the preferred embodiment shown and described above employs motors, other driving devices can be used, such as gearing or remote connection to some driving force. Further, the placement of the motors/drives can be altered.

While the position of Motor M1 is particular to the device, the motor M2 (or other drive means) can be positioned anywhere that allows it to change the angles of the parallelogram, such as at any corner of the structure. Motor M2 at Hinge/Joint H4 would perform equally well, and would also work at Hinge/Joint H1,H2, H6, and H7. Accordingly, the placement of the motors/drives shown are just examples of the preferred embodiment.

Accordingly, an improved motorized pentagram armature is shown and described, that allows for motorized positioning of the end of reach arm segment S1, for manual or automated positioning control.

While a preferred embodiment of the technology has been shown and described, it will be apparent to those skilled in the art that many changes and modifications may be made without departing from the broader aspects. The appended claims are therefore intended to cover all such changes and modifications as fall within the true spirit and scope of the technology.

1. (canceled)

2. (canceled)

3. (canceled)

4. A pentagram armature, comprising:
a bridge segment;
a reach side segment
a counter side segment;
a reach arm segment;
wherein said bridge segment hingedly connects to a first position of the reach side segment at a first position of the bridge segment and to a first position of the counter side segment at a second position of said bridge segment,
wherein said reach arm segment hingedly connects to a second position of the reach side segment at a first position of the reach arm segment and to a second position of the counter side segment at a second position of said reach arm segment;
a bridge segment rotation drive for rotating said bridge segment thereby moving the reach arm segment up or down; and
a pentagram corner angle drive for moving the angle of connection between said reach side segment and said bridge segment thereby moving the reach arm in and out.

5. The pentagram armature according to claim 4, further comprising a rotation drive for rotating the pentagram armature about a rotation position which moves an end of the reach arm end around a circle.

6. The pentagram armature according to claim 5, wherein said bridge segment rotation drive comprises a motor.

7. The pentagram armature according to claim 5, wherein said corner angle drive comprises a motor.

8. The pentagram armature according to claim 5, wherein said rotation drive comprises a motor.

9. The pentagram armature according to claim 4, further comprising a support mast mounting to said bridge segment, for supporting said armature above a surface.

10. The pentagram armature according to claim 5, further comprising a support mast mounting to said bridge segment, for supporting said armature above a surface, wherein said rotation drive rotates said support mast.

11. The pentagram armature according to claim 4, wherein said first position of the reach side segment where said bridge segment hingedly connects is at a first distal end of said reach side segment.

12. The pentagram armature according to claim 4, wherein said first position of the counter side segment where said bridge segment hingedly connects is at a first distal end of said counter side segment.

13. The pentagram armature according to claim 4, wherein said first position of the bridge segment where said bridge segment hingedly connects is at a first distal end of said bridge segment.

14. The pentagram armature according to claim 4, wherein said second position of the bridge segment where said bridge segment hingedly connects is at a second distal end of said bridge segment.

15. The pentagram armature according to claim 4, wherein said first position of the reach arm segment where said reach arm segment hingedly connects is at a first distal end of said reach arm segment.

16. The pentagram armature according to claim 4, wherein said second position of the counter side segment where said reach arm segment hingedly connects is at a second distal end of said counter side segment.

17. The pentagram armature according to claim 4, wherein said second position of the reach side segment where said reach side segment hingedly connects is at a second distal end of said reach side segment.

18. The pentagram armature according to claim 4, wherein said second position of the reach arm segment where said reach arm segment hingedly connects is at a first distal end of said reach arm segment.

19. The pentagram armature according to claim 18, wherein said first position of the reach arm segment where said reach arm segment hingedly connects is at a position spaced away from the first distal end of said reach arm segment.

20. A positionable pentagram armature, comprising:
a base support motor;
a support mast engaged with said base support motor for rotation of said base support mast by operation of said base support motor;
a bridge segment rotationally mounted to said support mast distal from said base support motor;
a bridge segment motor for rotating said bridge segment about said support mast;
a counter side segment mounted to said bridge segment at a first end of said counter side segment and a first end of the bridge segment;
a reach side segment mounted to said bridge segment at a first end of the reach side segment and a second end of the bridge segment;
a reach arm segment mounted at a first end reach arm segment to a second end of said counter side segment and to a second end of said reach side segment at a second position of said reach arm segment;
a corner angle motor mounted for rotational movement of said counter side segment and said reach side segment relative to said bridge segment;
whereby operation of said base support motor, said bride segment motor and said corner angle motor allow positioning of a distal end of said reach arm segment to a location.
